(19) United States
(12) Patent Application Publication
(10) Pub. No.: US 2009/0067949 A1
(43) Pub. Date: Mar. 12, 2009

(54) Dual hardness connector

(75) Inventor: Garry L. Dillon, Kenosha, WI (US)

Correspondence Address: SEYFARTH SHAW LLP, 131 S. DEARBORN ST., SUITE 2400, CHICAGO, IL, 60603-5803, US

(73) Assignee: Snap-on Incorporated

(21) Appl. No.: 12/268,825

(22) Filed: Nov. 11, 2008

Related U.S. Application Data
(62) Division of application No. 11/650,382, filed on Jan. 5, 2007.

(51) Int. Cl. F16B 19/04

(52) U.S. Cl. 411/500

(57) ABSTRACT

A connector includes a body having a first portion and a second portion integrally formed with the first portion. The first portion has a first hardness and the second portion has a second different hardness. In an embodiment, the first portion has a first hardness of at least 40 Rockwell C and the second portion has a second hardness that is less than the first hardness. In another embodiment, the second portion has a hardness of 30 Rockwell C or less and the first portion has a greater hardness than the hardness of the second portion. The connector is made using a method including the steps of forming a body having first and second portions, and induction hardening the first portion to a hardness of at least 40 Rockwell C or the second portion to a hardness of 30 Rockwell C or less.

### BACKGROUND

Connectors, such as rivets, are used to join different work pieces together. The connectors come in all different shapes and sizes. One type of connector, a rivet, is used to join different work pieces together by inserting the rivet through both work pieces and then deforming one or both ends of the rivet to be wider or larger than the openings through which the rivet was inserted. This causes the rivet to stay in place and also enables the rivet to hold the different work pieces together.

Connectors, such as rivets, which are used to join moving parts together, such as the moving parts of a pair of scissors or pliers, are subject to friction forces which may cause the connectors to wear and eventually fail. Specifically, the moving parts wear down the top or head portion of the rivet due to the friction generated between each of the moving parts and the head portion.

In certain pivoting lever tools, such as pliers, it is necessary that certain parts of the tool levers be hardened. Heretofore, this was typically done by heat treating the entire tool after assembly. This method, however, resulted in the misalignment of the edges of the moving parts, such as the cutting edges of the tool levers, due to warpage that occurs at the high temperatures of the heat treatment process. A solution was to heat treat the parts separately, before assembly. However, where the lever connector is a rivet, this resulted in the rivet being too hard to be deformed after assembly.

Two-part or bimetal rivets formed of different hardness materials have been utilized, but this complicates the fabrication of the rivet.

In another method, a threaded hardened fastener is used to join two moving parts together and a nut is secured to the end of the shank portion of the fastener by welding or other suitable connection method. Additionally, in a further method, a significantly hardened rivet is used to join the moving parts together and the end of the rivet is then welded into place. These methods, however, require extra steps to achieve the finished product which is both time consuming and expensive. Also, the welding location on the rivets, which is weaker than the rest of the rivets, is subject to breaking.

Accordingly, there is a need for an improved rivet connector which resists wear and can be formed to secure the connector in place.

### SUMMARY

The application is directed to connector and more specifically, to a connector, such as a rivet, having a first portion and a second portion integrally formed with the first portion where the first portion has a first hardness and the second portion has a second hardness that is different from the first hardness.

One embodiment provides a connector including a body having a first portion and a second portion integrally formed with the first portion. The first portion has a first hardness of at least 40 Rockwell C and the second portion has a second hardness that is less than the first hardness.

In an embodiment, the first portion is a head portion and the second portion is a shank portion.

In an embodiment, the first portion and the second portion are made of the same material.

In an embodiment, the first portion and the second portion are made of steel.

In an embodiment, the body defines a rivet.

In an embodiment, the second hardness is 30 Rockwell C or less.

Another embodiment provides a connector including a body having a first portion and a second portion integrally formed with the first portion. The second portion has a hardness of 30 Rockwell C or less and the first portion has a hardness that is greater than the hardness of the second portion.

In an embodiment, the first portion is a head portion and the second portion is a shank portion.

In an embodiment, the first portion and the second portion are made of the same material.

In an embodiment, the first portion and the second portion are made of steel.

In an embodiment, the first portion has a hardness of at least 40 Rockwell C.

In an embodiment, the body defines a rivet.

A further embodiment provides a tool including a first member, a second member and a connector connected to the first and second members at a pivot point. The first and second members each adapted to pivot about the pivot point. The connector having a first portion and a second portion, where the first portion has a first hardness and the second portion has a second different hardness that is less than the first hardness.

In an embodiment the first portion and the second portion are made of the same material.

In an embodiment, the first portion and the second portion are made of steel.

In an embodiment, the connector is a rivet.

In an embodiment, the tool is a pliers.

In an embodiment, the first hardness is at least 40 Rockwell C and the second hardness is 30 Rockwell C or less.

A further embodiment provides a method of forming a connector including forming a body having first and second portions, and induction hardening the first portion to a hardness of at least 40 Rockwell C.

Another embodiment provides a method of forming a connector including forming a body having first and second portions, and induction hardening the second portion to a hardness of 30 Rockwell C or less.

Accordingly, an advantage is to provide a connector having a first portion having a hardness and a second portion having a different hardness.

Another advantage is to provide a connector having a first portion having a first hardness and a second portion having second hardness where the first hardness is greater than the second hardness.

A further advantage is to provide a connector for connecting movable members where the connector has a first harder portion which resists wear due to the moving members and a second softer portion which is deformable into a retaining head to secure the members together.

Other objects, features and advantages will be apparent from the following detailed disclosure, taken in conjunction with the accompanying sheets of drawings, wherein like numerals refer to like parts, elements, components, steps and processes.

### DESCRIPTION OF THE FIGURES

FIG. 1 is a side view of an embodiment of a rivet connector before deformation.

FIG. 2 is a left side view of an assembled tool including the connector of FIG. 1.

FIG. 3 is a right side view of the tool FIG. 2.

### DETAILED DESCRIPTION

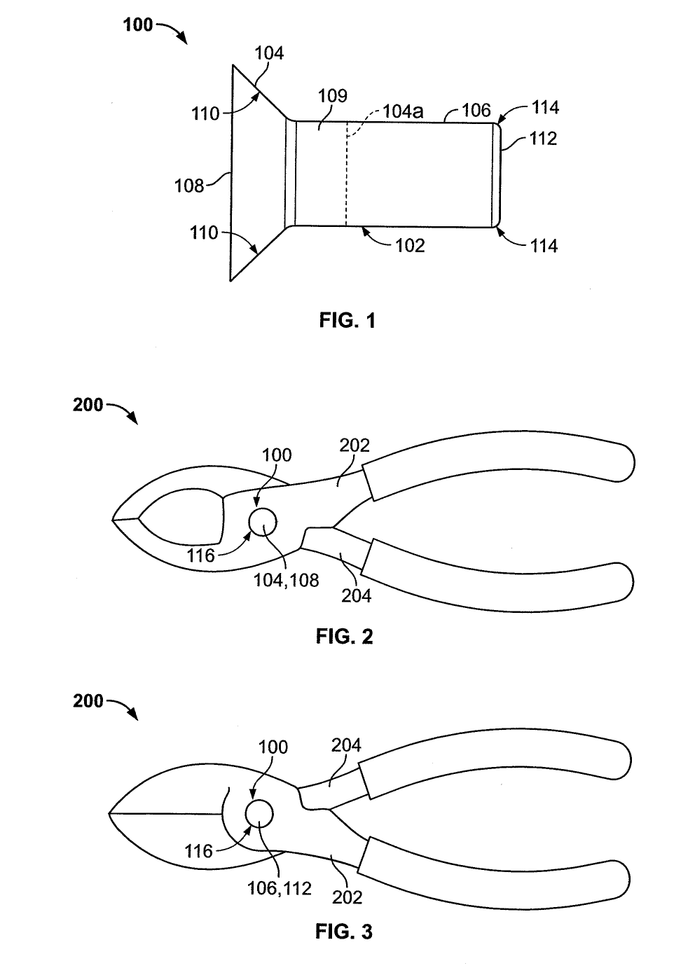

Referring now to FIG. 1, in an embodiment, a connector such as a rivet 100 is provided to connect different parts together. Specifically, the rivet 100 includes a body 102 having a first portion or head portion 104 and a second portion or shank portion 106, the dividing line between the head and shank portions being designated by the dot-dash line 104a. In the illustrated embodiment, the body 102 is of unitary, one-piece construction. However, the head portion and shank portion could be separate components which are joined together by any suitable connection method, such as welding. The body 102 is made so that the head portion 104 has a first hardness and the shank portion 106 has a second different hardness.

In an embodiment, the first hardness is greater than the second hardness. Specifically, in an embodiment, the hardness of the head portion is at least 40 Rockwell C and the hardness of the shank portion is 30 Rockwell C or less. These hardness levels provide the head portion 104 with a sufficient hardness to significantly resist wear from moving parts of a tool interconnected by the rivet 100, and the shank portion to be soft enough to be cold formed into a retaining head which secures the rivet in place. It should be appreciated that the first hardness and the second hardness could have different values than those mentioned above, depending on the application, as long as the head portion is sufficiently hard to provide the necessary wear resistance and the shank portion is sufficiently soft to permit cold deformation.

In the illustrated embodiment, the head portion 104 and the shank portion 106 are made of the same material. However, the head portion and the shank portion could be made of the same material, different materials, the same combination of materials, or different combinations of materials. It should also be appreciated that the connector or rivet 100 may be any suitable size or shape.

In the illustrated embodiment, the head portion 104 is formed to have a generally flat or planar top surface 108 and angled or beveled side portions 110 which angle away from the top surface 108 towards a cylindrical portion 109 of the head portion. It should be appreciated that the side portions 110 may be inclined or slanted at any suitable angle.

The shank portion 106 has the same cylindrical shape as the cylindrical portion 109 of the head portion 104. The shank portion 106 includes a flat or planar end 112. The end 112 includes angled, beveled or tapered side surfaces 114. It should be appreciated that the side surfaces 114 may be at any suitable angle.

In an embodiment, the rivet 100 is made or formed by a method that includes forming a body having first and second portions and induction hardening the first portion to a hardness of at least 40 Rockwell C. In another embodiment, the method of forming the connector includes forming a body having first and second portions, and induction hardening the second portion to a hardness of 30 Rockwell C or less. In a further embodiment, the method includes forming a body having first and second portions and then induction hardening the first portion to a hardness of at least 40 Rockwell C and the second portion to a hardness of 30 Rockwell C or less. It should be appreciated that other suitable methods may be used to form the rivet 100.

Referring now to FIGS. 2 and 3, an example of a tool utilizing the connector of FIG. 1 is illustrated where the connector 100 joins the first and second moveable lever members 202 and 204 of a pair of pliers 200. Specifically, the connector 100 is inserted into corresponding openings defined by the first and second members 202 and 204 to join these members together at a pivot point 116. Specifically, the connector 100 is inserted through the openings in the first and second members 202 and 204 until the top surface 108 of the head portion 104 is substantially flush or level with the outside surface of one of the first and second members 202 and 204, and the shank portion 106 projects beyond the other of the members 202 and 204. Then the projecting portion of the shank portion 206 is deformed, by suitable known means, to form a retaining head or flattened portion at the end 112 of the shank portion 106.

The retaining head or flattened portion at end 112 prevents the connector 100 from coming out of or being removed from the openings defined by the first and second moveable members 202 and 204. This enables the connector 100 to secure the first and second moveable members 202 and 204 together. After the 202 is assembled, the harder head portion minimizes or resists the wear on the head portion created by the friction between the moving first and second members 202 and 204. This enables the connector 100 to last significantly longer and minimize costs as well as makes the tool last longer which improves customer satisfaction with the tool.

The softer end 112 of the shank portion 106 enables at least a portion of the shank portion to be deformed into a retaining head or flattened, ridge-like portion, which secures the connector 100 in place to hold the first and second moveable members 202 and 204 together.

It should be appreciated that although all of the above embodiments show the connector 100 being used in pliers, the connector may be used with any suitable tool or tools. Additionally, one connector or a plurality of connectors may be used to secure one or more work pieces together.

In the above embodiments, the head portion has a first hardness which is greater than the second hardness of the shank portion. It should be appreciated that any suitable portion or portions of the connector 100 may have a hardness which is greater than other portions of the connector.

The embodiments set forth in the foregoing description and accompanying drawings is offered by way of illustration only and not as a limitation. While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. A method of forming a connector comprising:
forming a body having first and second portions, and
induction hardening the first portion to a hardness of at least 40 Rockwell C.

20. A method of forming a connector comprising:
forming a body having first and second portions, and
induction hardening the second portion to a hardness of 30 Rockwell C or less.
